(19) United States
(12) Patent Application Publication
(10) Pub. No.: US 2009/0287676 A1
(43) Pub. Date: Nov. 19, 2009

(54) SEARCH RESULTS WITH WORD OR PHRASE INDEX

(75) Inventor: Ali Dasdan, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/122,139

(22) Filed: May 16, 2008

(51) Int. Cl. G06F 17/30

(52) U.S. Cl. 707/5; 707/E17.015

(57) ABSTRACT

Disclosed are apparatus and methods for providing a word or phrase index regarding a particular set of search results. In specific embodiments, a word or phrase index for summarizing the words or phrases (or a subset of same) within the particular search results may be determined. This index may be similar to the inverted index used by some search engines so that each of a plurality of words or phrases are associated with a plurality of search results (e.g., web pages and/or their cached copies) that contain such each word or phrase. The index is determined based on the search results, and the index for the search results is then provided along with the search results. The entries of the provided search result index are preferably selectable so that a user can access the search results that contain at least one of the listed word or phrase in the index.

### BACKGROUND OF THE INVENTION

The field of the invention includes search services provided over a computer network. The field especially pertains to providing search results and associated information in response to a search term query or within another type of object browsing or search application.

In recent years, the Internet has been a main source of information for millions of users. These users rely on the Internet to search for information of interest to them. One conventional way for users to search for information is to initiate a search query through a search service's web page. Typically, a user can enter one or more search term(s) into an input box on the search web page and then initiate a search based on such entered search term(s). In response to a query, a web search engine generally returns an ordered list of search result documents. The list of search results may include a title, a universal resource locator (URL) link, and an abstract.

FIG. 1 is a screen shot showing a portion of a search web page 100 in which a search query has been initiated for the search term “orange” 102 and a list of search results 104 have been presented based on such search term “orange” 102. As shown, each entry in the list of search results 104 typically includes a title (e.g., title 106a and 106b), a universal resource locator (URL) link (e.g., 110a and 110b), and an abstract (e.g., 108a and 108b). The abstract gives a concise summary to the user that indicates something about why the associated search result document is relevant for the particular query, and the title may provide an even briefer description of the search result document. Although the title and abstract together provide information regarding a particular search result link, it would be beneficial to provide improved mechanisms for presenting search results.

### SUMMARY OF THE INVENTION

In certain embodiments of the present invention, apparatus and methods for providing a word or phrase index regarding a particular set of search results are disclosed. In specific embodiments, a word or phrase index for summarizing the words or phrases (or a subset of same) within the particular search results may be determined. This index may be similar to the inverted index used by some search engines so that each of a plurality of words or phrases are associated with a plurality of search results (e.g., web pages and/or their cached copies) that contain such each word or phrase. The index is determined based on the search results, and the index for the search results is then provided along with the search results. The entries of the provided search result index are preferably selectable so that a user can access the search results that contain at least one of the listed word or phrase in the index.

In one embodiment, a method for method for providing search results to a user of a search service is provided. When a plurality of search results are provided for a search query by a user, a word or phrase index for at least a portion of the search results is obtained. The word or phrase index includes a plurality of words or phrases that are each associated with one or more search results that contain or use such associated words or phrases. The word or phrase index is provided, along with the search results, to the user so that the search results of the word or phrase index are selectable by the user.

In a specific implementation, the search results are documents, audio files, video files, or image files. In another aspect, a metric is determined for each word or phrase and/or for each search results of each word or phrase. In a further aspect, the metrics are presented as numbers. In another aspect, the metrics are presented as a visual map. In yet a further aspect, the metric include one or more of the following: a count, a word frequency for the current search query, a word frequency for a plurality of search queries, a word frequency in anchor texts of the search results, a word frequency in user tags of the search results, a word frequency with respect to one or more search terms of the current search query or a plurality of search queries, a search result ranking metric, a term frequency (tf) metric, an inverse document frequency (idf) metric, or a tf-idf metric. In one embodiment, the words or phrases of the word or phrase index are presented in an order based on the metrics.

In another implementation, the words or phrases of the word or phrase index are presented in an order that corresponds to a frequency metric. For example, the frequency metric is a term frequency-inverse document frequency (tf-idf) metric. In one feature, the words or phrases of the word or phrase index are hierarchically presented. In another feature, the words or phrases of the word or phrase index are shown by a visual representation that corresponds to a metric of such words or phrases. In another embodiment, a subsequent search is altered based on the determined word or phrase index and/or user selection of one or more portions of the word or phrase index. In yet another embodiment, the word or phrase index is obtained only for the search results that are related to advertisements.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a screen shot showing a portion of a search web page in which a search query has been initiated and a list of search results have been presented based on such search query.

FIG. 2 illustrates an example network segment in which the present invention may be implemented in accordance with one embodiment of the present invention.

FIG. 3 is an example inverted word index.

FIG. 4 is a flow chart illustrating an index management procedure in accordance with one embodiment of the present invention.

FIG. 5 is a flow chart illustrating a procedure for determining a word index for search results in accordance with one implementation of the present invention.

FIG. 6A is a screen shot of a plurality of search results and a word index for such search results in accordance with one embodiment of the present invention.

FIG. 6B is an example dynamic word index in accordance with a first implementation of the present invention.

FIG. 6C illustrates a dynamic and hierarchical word index in accordance with a second implementation of the present invention.

FIG. 6D illustrates a word index map in accordance with another implementation of the present invention.

FIG. 7 illustrates an example computer system in which specific embodiments of the present invention may be implemented.

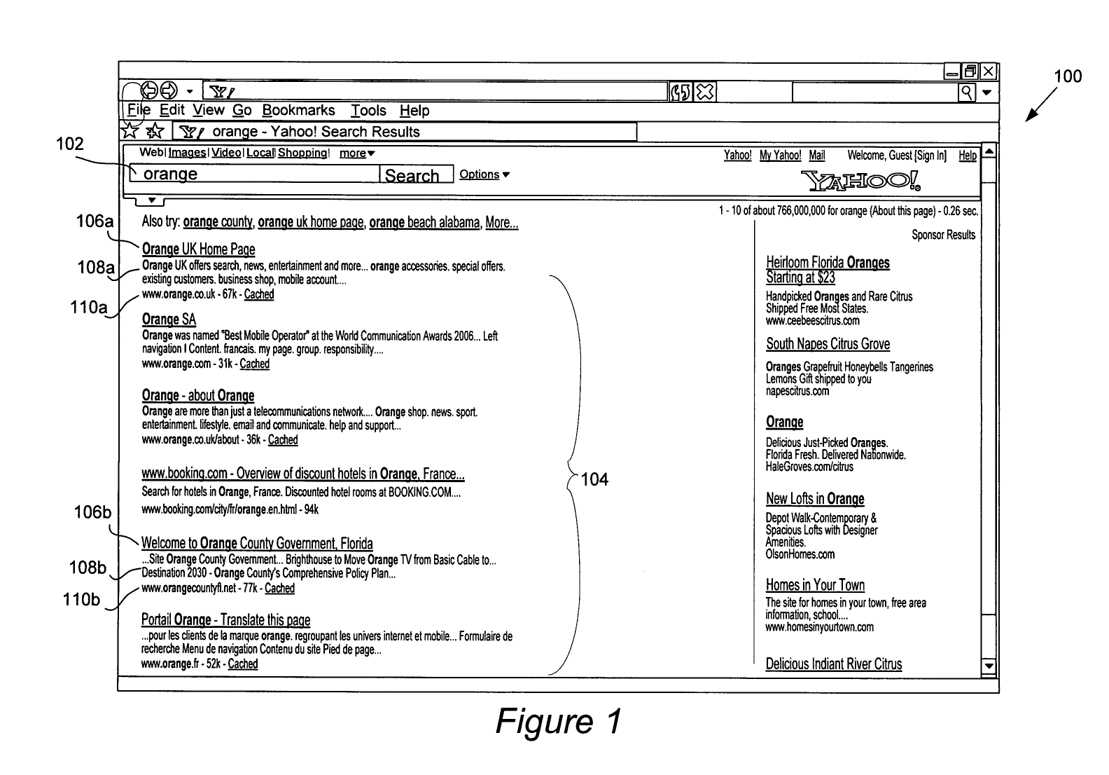

### DETAILED DESCRIPTION OF THE SPECIFIC EMBODIMENTS

Reference will now be made in detail to specific embodiments of the invention. Example embodiments are illustrated in the accompanying drawings. While the invention will be described in conjunction with these specific embodiments, it will be understood that they are not intended to limit the invention to these embodiments. On the contrary, these embodiments are intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details.

In general, a word or phrase index is determined for a set of search results and this index is provided along with the search results. The search results may take any suitable form, such as web pages, images, videos, audio files, or any object for which a word or phrase index may be provided. In one embodiment, when a user performs a search query, a word or phrase index for the search results (or a subset of such search results) is provided to the user along with the presented search results as described further below.

Example embodiments of the present invention may be utilized to significantly enhance the search interface and search experience. The word or phrase index can help a user navigate through a high number of search results and find related pages.

Although certain embodiments are described herein in relation to search results and an associated word or phrase index in the context of a search service application, it should be apparent that a word or phrase index may also be provided in other applications, such as a music or video service for browsing/searching through audio visual objects. For example, a word index could correspond to the lyrics within a song or music video or to the text that is displayed (e.g., subtitles) or used (e.g., unseen tags) for an image or video.

The phrase “word index” will be used herein to refer to both a word and phrase index. It should also be noted that embodiments of the invention are contemplated in which the operation of the underlying search engine can remain largely unaffected by processes for determining and providing of a word index. That is, in response to a search query, the search engine may acquire information relating to the search query as it would conventionally, i.e., without the benefits of or reference to the word index of the present invention. The word index may be determined and applied to the conventionally retrieved results. However, embodiments are also contemplated in which the operation of the underlying search engine is altered in some way to enable at least some further search enhancements as described further below. For example, the ranking of the subsequent search results and/or the search engine may be affected by user selection of particular search results via the provided word index.

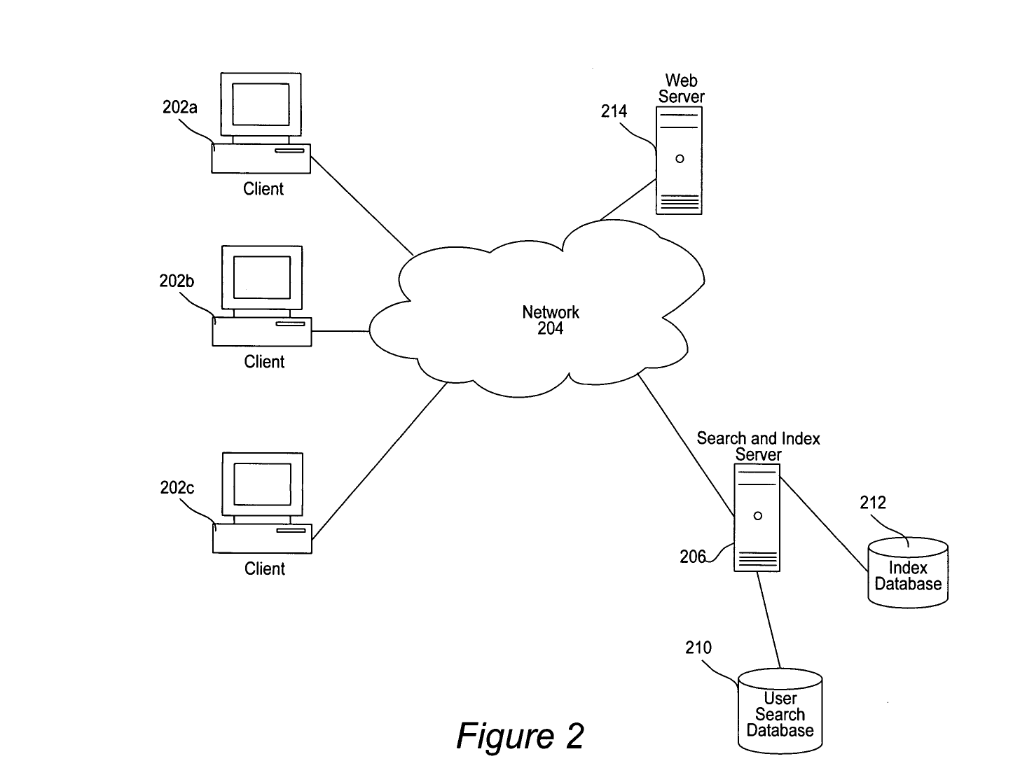

Prior to describing mechanisms for providing a word index, a search and web architecture will first be briefly described to provide an example context for practicing techniques of the present invention. FIG. 2 illustrates an example network segment in which the present invention may be implemented in accordance with one embodiment of the present invention. As shown, a plurality of clients 202 may access a search application, for example, on search and index server 206 via network 204 and/or access a web service, for example, on web server 214. The network may take any suitable form, such as a wide area network or Internet and/or one or more local area networks (LAN's). The network 204 may include any suitable number and type of devices, e.g., routers and switches, for forwarding search or web object requests from each client to the search or web application and forwarding search or web results back to the requesting clients.

The invention may also be practiced in a wide variety of network environments (represented by network 204) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via network 204 and related to one or more search terms. The search terms may be entered by a user in any manner. For example, the search application may present a web page having any input feature to the client (e.g., on the client's device) so the client can enter one or more search term(s). In a specific implementation, the search application presents an input box into which a user may type any number of search terms. Embodiments of the present invention may be employed with respect to any search application, and example search applications include Yahoo! Search, Google, Altavista, Ask Jeeves, etc. The search application may be implemented on any number of servers although only a single search server 206 is illustrated for clarity and simplification of the description.

The search and index server 206 (or servers) may have access to one or more user search database(s) 210 into which search information is retained. Each time a user performs a search on one or more search terms (e.g., a search session occurs), information regarding such search may be retained in the user search database(s) 210. For instance, the user's search request may contain any number of parameters, such as user or browser identity and the search terms, which may be retained in the user search database(s) 210. Additional information related to the search, such as a timestamp, may also be retained along with the search request parameters. When results are presented to the user based on the entered search terms, parameters from such search results may also be retained. For example, the specific search results, such as the web sites, the order in which the search results are presented, whether each search result is a sponsored or algorithmic search result, the owner of each search result, whether each search result is selected by the user (if any), and a timestamp may also be retained in the user search database(s) 210. The retained user search information may later be used to affect certain aspects of the present invention.

The search and index server 206 may also be configured to determine a word index. Alternatively, a separate index server may be utilized. Two types of word indexes may be determined by the search and index server 206. The search and index server 206 may determine a search word index based one or more web crawlers that are configured to locate and analyze a large number of web documents. Such a search word index may be stored in index database 212. Alternatively, one or more search word indexes may be provided by one or more other search or web servers and accessed when needed by a particular search server. The search and index server 206 may also determine and provide a word index for particular search results of particular search sessions as described herein.

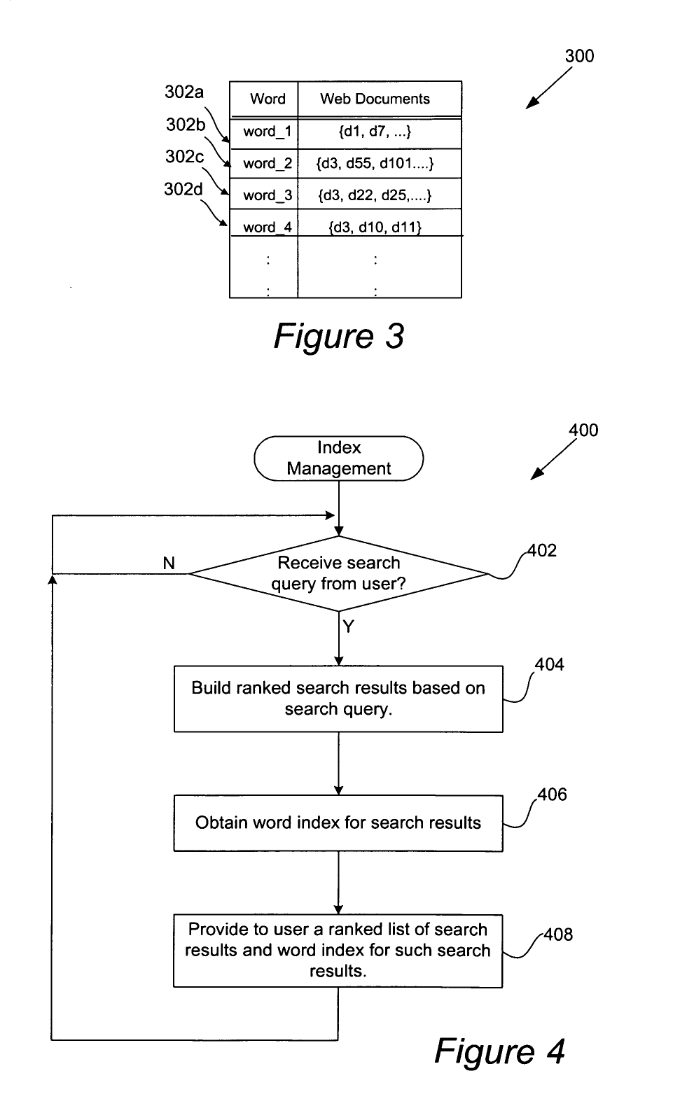

The search word index that is determined by a web crawler or the word index that is determined for a set of search results may take any suitable form. FIG. 3 is an example inverted word index that is determined by one or more web crawlers. As shown, the inverted word index includes a plurality of entries, e.g., 302a-d, that relate words to a set of web documents that contains such words. For instance, documents d1 and d7 are shown in entry 302a as containing word “word_1”, while documents d3, d55, and d101 include word “word_2”. The positions of these words in these documents may also be stored in such an index. This word index may later be utilized for a set of search results so as to generate a new word index for such search results as described further below.

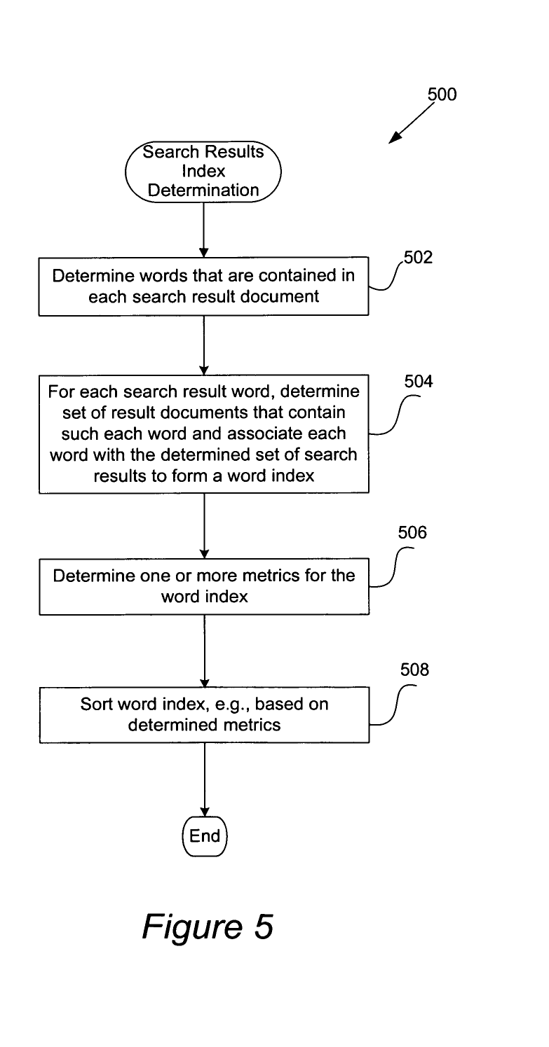

FIG. 4 is a flow chart illustrating an index management procedure 400 in accordance with one embodiment of the present invention. In this example, word indexing is applied in a search results context. For instance, an index management process may be integrated with a search service application, or a search application may provide search session notifications and search result information to an independent index management process that may be implemented on a same or different device. Accordingly, it may be initially determined whether a search query has been received from a user in operation 402. If a search has not been initiated, the procedure waits. Otherwise, ranked search results may then be built based on this search query in operation 404.

The search results may be provided in any suitable manner. In one embodiment, when a search for objects, such as web documents, based on one or more search terms is initiated in a query to a search server, a search server can locate a plurality of search results that relate to the search terms. These search results can be found on any number of web servers and usually enter the search server via a crawling and indexing pipeline possibly performed by a different set of computers (not shown). The plurality of located search results may then be analyzed by a rule based or decision tree system to determine a “goodness” or relevance ranking. For instance, the search results are ranked in order from most relevant to least relevant based on a plurality of feature values of the search results, the user who initiated the search with a search request, etc.

After ranked search results are built for a particular search query by a user, a word index for the search results may then be obtained in operation 406. A ranked list of search results and the word index for such search results may then be provided to the user (e.g., a device accessible by such user) in operation 408. For example, the word index is provided adjacent to the search results and allow user interaction with such provided word index and search results as described further below. The procedure may be repeated for a next search query.

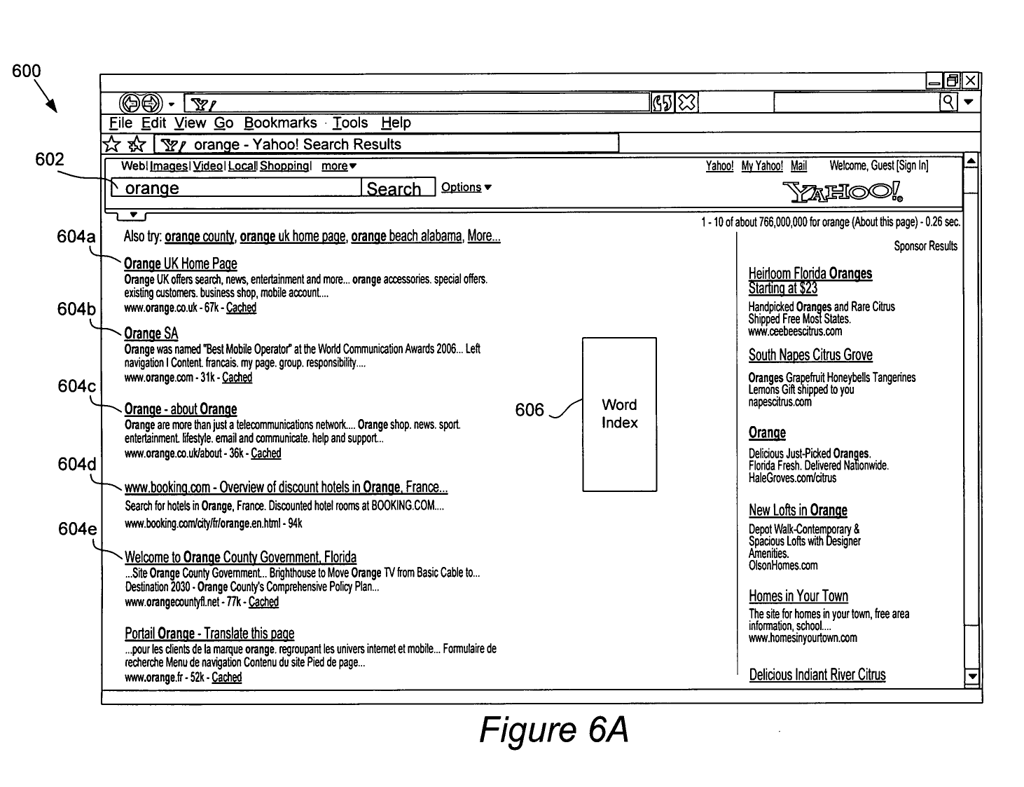

A word index for the search results may be determined in any suitable manner and have any suitable format for specifying the words (or phrases) of one or more of the search results. FIG. 5 is a flow chart illustrating a procedure 500 for determining a word index for search results in accordance with one implementation of the present invention. Initially, the words that are contained in each search result document may be first determined in operation 502. For example, it is determined which words are in each search result document. In another example, it may be determined which words are “used” by each search result document (e.g., in song or video lyrics, etc.) In a specific implementation, the words of each search result may be determined by analyzing one or more search indexes and forming a subset based on the current set of search results. As an example for the word index of FIG. 3, if the search results only include documents d1 and d10, then it may be determined that the search results only include words “word_1” and “word_4”, for which a word index may be created. Alternatively, the words of the search results may be determined independently of a search word index by examining the search results for word content or usage.

For each search result word, a list of search result documents that contains each word may also be determined in operation 504. Each word may also be associated with its determined set of search results to form a word index in operation 504. Any suitable word index data structure may be created (and retained) to associate each word with its corresponding set of search results. For the above example search results that include only documents d1 and d10, the word index that is created could be similar to the example of FIG. 3, but would include only entries 302a and 302b, which are the only entries that contain search results d1 or d10. That is, the word index would contain entry 302a that associates word “word_1” with search results d1, d7, etc. and entry 302d that associated word “word_4” search results d3, d10, d11, etc.

A word index may be determined with respect to all of the search results, a portion of the search results, each the search results, or each of a subset of the search results. In a specific implementation, it may first be determined which words are within any of the entire set or a subset of the search results. In a subset example, it is determined which words or phrases are present within only the search results that correspond to sponsor or advertisement search results (e.g., web pages that belong to owners that have bid and bought (or could bid and buy) the one or more search terms of the current search query). Whether determining which words are present in either the entire search results or a portion of the search results, a search result set may then be determined for each of these words.

In a specific implementation aspect, common informational retrieval techniques such as stemming and stopword removal may be used to process the words so that the word index can focus on the most relevant or important words from the search results. For example, stemming may help replace “going” or “went” with “go”, and the stopword removal may help remove “a”, “the”, “was”, and the other stopwords.

Referring back to the illustrated example, one or more metrics may also be determined for the word index in operation 506. Any suitable metric may be determined. A metric may be determined for each word and/or for each search result associated with each word. Suitable metrics may include one or more of the following: a count, a word frequency for the current search, a word frequency for previous searches, a word frequency in anchor texts, a word frequency in user tags, a word frequency in search terms, a search result ranking (based on clicks or otherwise), a term frequency (tf) metric, an inverse document frequency (idf) metric, a tf-idf metric, etc.

A count may be defined as the occurrence of each of the index words in the search results, a portion of the search results, or in each corresponding search result. The tf-idf metric is a statistical measurement that corresponds to a word's importance within a particular document or set of documents. There are many ways to determine a tf-idf metric. A tf (term frequency) metric may be defined as the number of times a particular word occurs in a document or a corpus of documents divided by the total number of words. For example, if the word “pickle” occurs 4 times in a 100 word document, then the tf metric for “pickle” can be defined as 0.04. A df (document frequency) metric can then be defined as the total number of documents in which the word appears divided by the total number of documents. For instance, if “pickle” appears in 500 documents out of a total of 1,000,000 documents, the df for “pickle” can be defined as 0.0005. A final tf-idf metric for “pickle” can then be defined by multiplying tf by the inverse of df, hence, the term “idf”, which results in 8000 (0.04*1/0.0005). Another tf-idf technique would be to take the log or natural log of the document frequency. Other forms of the tf-idf metric may be defined depending on the application.

Referring back to FIG. 5, the word index may then be sorted, e.g., based on the determined metrics in operation 508, and the word index determination procedure then ends. The word index may be sorted based on any suitable criteria, such as alphabetically or based on an order that corresponds to any metric, e.g., as described above. For example, the word index may be sorted in an order of frequency or some other score, such as tf-idf.

Although a word index is described with respect to the process 500 of FIG. 5, of course, this process could be modified to determine a phrase index. For instance, a plurality of phrases, which each include 2 up to a predefined limit of words, may be determined to be present within the search results, and each existing phrase can then be associated with its corresponding search results. If a phrase contains N words, it is sometimes referred to as an n-gram. One or more metrics may then be determined for the resulting phrase index, and the phrase index may then be sorted in any way described herein.

A word index (or phrase index) may be provided with search results to a user in any suitable manner or format. In general, the word index may be dynamic or static. The entire word index may be presented as a single unit (e.g., scrollable) or in multiple selectable pieces as described further below. The provided word index may also be displayed with one or more metrics that are statically or dynamically displayed. The metrics can be displayed as numbers or by some form of visual representation or map. The word index may be displayed in an order based on any suitable metric, e.g., a frequency or a tf-idf metric.

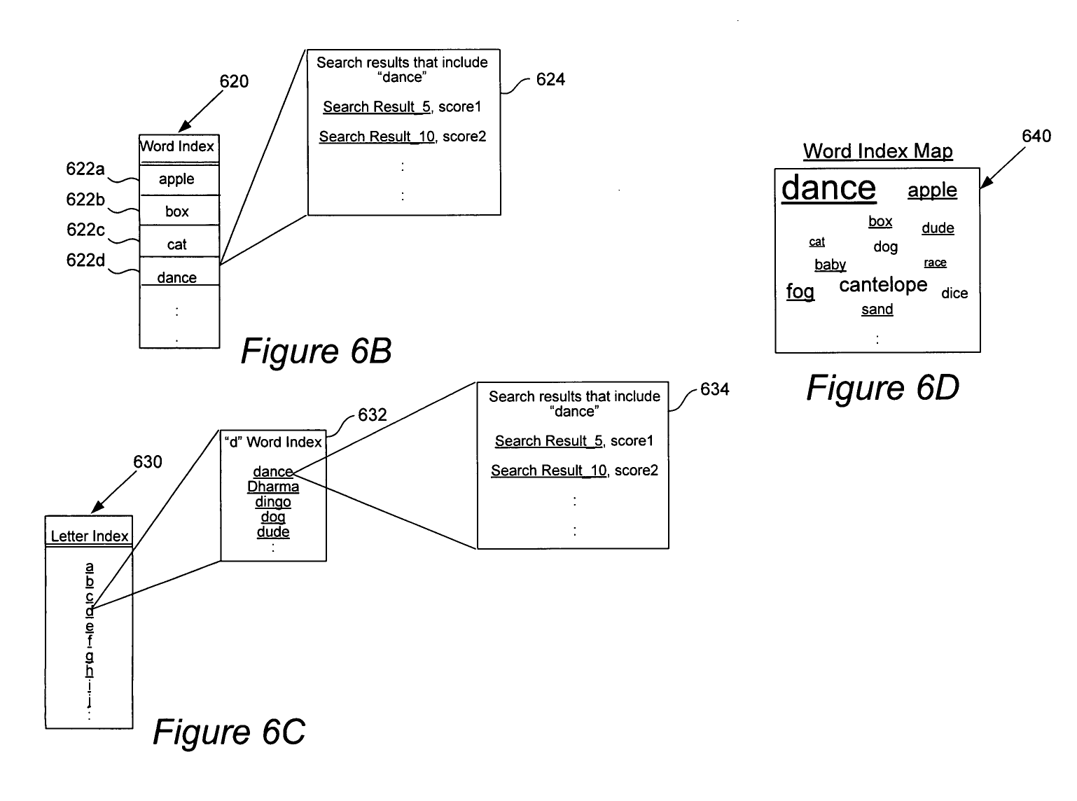

FIG. 6A is a screen shot 600 of a plurality of search results, e.g., 604a-604d, and a word index 606 for such search results in accordance with one embodiment of the present invention. The search results may be displayed in a scrollable window 600. The word index 606 may be provided in any portion of the search results window 600. As shown, the word index 606 is presented adjacent to the displayed search results 604. In this example, there is a single word index 606 for all of the search results 604. However, word indexes may be provided for each search result 604 or a subset of search results, such as the top predefined number, e.g., 10, of search results.

The word index 606, which is initially presented with the search results, may show only the words or the show both the words and their associated search results. The word index may also be displayed with one or more metrics for such words or their associated search results. Regardless of form, the search results of the word index are preferably user selectable so that the selected search result is provided to the user.

FIGS. 6B-6D illustrate example word indexes that can be displayed along with a plurality of search results. The search results of the search query are not shown so as to simplify the illustration. However, any portion of these word indexes of FIGS. 6B-6D may be displayed along with the search results, for example, as word index 606 along with the search results of FIG. 6A.

FIG. 6B is an example dynamic word index 620 in accordance with a first implementation of the present invention. As shown, the word index 620 includes a plurality of listed words 622a-622d, for example. When a user selects or clicks on one of these words, a web page or document 624 may then be presented to the user, together or separately from the initially presented word index. In the example of FIG. 6B, the user has selected the index word “dance”, and the window 624, which contains search results links for such selected word, is then presented to the user.

In the illustrated example, each search result of the word index is selectable by the user, and each search result of the word index is also associated with a metric (e.g., score1 and score2, respectively) that is displayed to the user. A metric may be additionally or alternatively associated with each word. In one implementation, the metric is displayed as a number although other types of visual representations of a metric scale may be used as described further herein.

FIG. 6C illustrates a dynamic and hierarchical word index 630 in accordance with a second implementation of the present invention. As shown, the word index may initially be presented to the user as a letter index 630. When the user selects a particular letter, a word index document 632 for the selected letter may then be presented to the user. As shown, word index 632 for the selected letter “d” is displayed to the user.

The word index 632 may include a plurality of words that start with the selected letter, e.g., d, and each word of the word index 632 may also be selectable by the user so as to display an associated list of search results. Alternatively, the search results may be displayed in the word index 634. In the example of FIG. 6C, when the user selects a particular word, a web page 634 that includes a list of search result documents for the selected word may then be presented to the user. The search results list may include selectable links for such associated search results, as well as one or more metrics. The words may also include metrics (not shown).

In the example of FIGS. 6B and 6C, the words of the word index are alphabetically ordered. However, the words may be ordered based on any one or more metrics. Besides an ordered list, the words of the word index may also be ordered in another visual way to indicate relative metrics that are associated with the words. Additionally, the number of search results that are provided and/or displayed for each word may be limited to a predefined number. The displayed search result links may correspond to any subset of the search result, such as the most popular or highest ranking search results, or the search results that contain the highest count of the associated word.

FIG. 6D illustrates a word index map 640 (e.g., a tag or data cloud format) in accordance with another implementation of the present invention. As shown, the word index map can take the form of a nonlinear arrangement of words that each includes one or more visual aspects corresponding to a metric value, such as frequency or count. Visual aspects that correspond to a metric scale may include color, font type, font size, a shape with a particular size that is associated with each word (e.g., different sized circles that each encompass one of the index words), etc. As shown, the words have different fonts corresponding to a metric. For example, a word that has a higher frequency metric may have a larger font than another word that has a lower frequency.

A user's interaction the search results word index may also be collected and used for any suitable purpose. For example, the interactions by a plurality of users with a plurality of word indexes may be used to adjust ranking algorithms or the search index. In another example, the interactions may be used by companies to determine the content or type of advertisement that such company is to use in the context of searches.

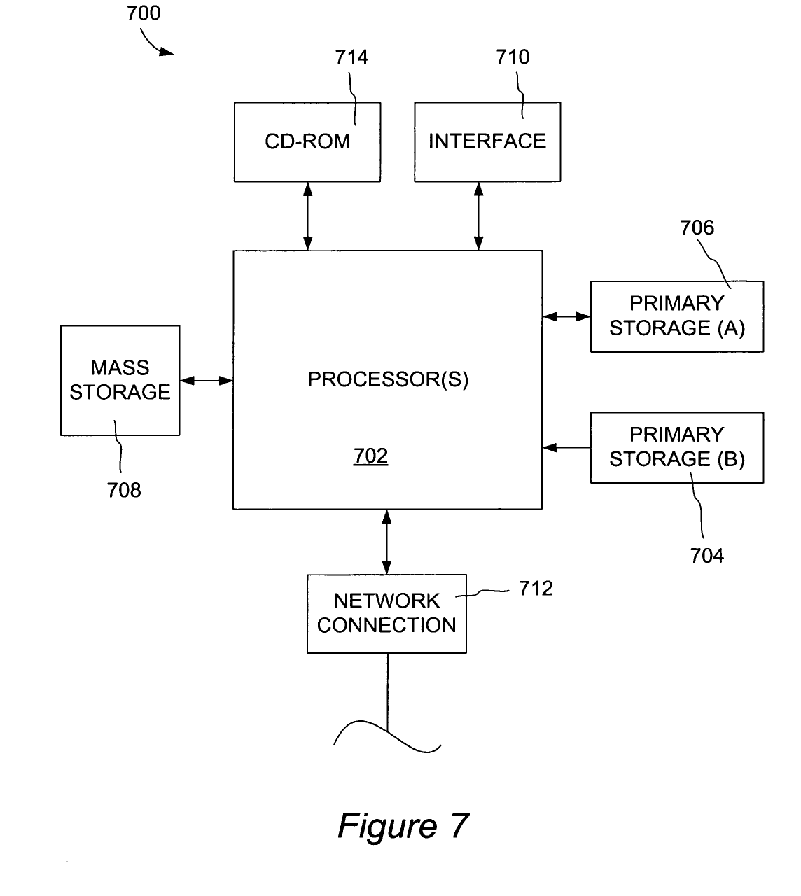

The present invention may be implemented in any suitable combination of hardware and/or software. FIG. 7 illustrates a typical computer system that, when appropriately configured or designed, can serve as a word index manager of this invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store user search database(s), user web information database(s), word index database(s), word index metrics, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for providing search results to a user of a search service, comprising:
when a plurality of search results are provided for a search query by a user, obtaining a word or phrase index for at least a portion of the search results, wherein the word or phrase index includes a plurality of words or phrases that are each associated with one or more search results that contain or use such associated words or phrases; and
providing the word or phrase index, along with the search results, to the user so that the search results of the word or phrase index are selectable by the user.

2. A method as recited in claim 1, wherein the search results are documents, audio files, video files, or image files.

3. A method as recited in claim 1, further comprising determining a metric for each word or phrase and/or for each search results of each word or phrase.

4. A method as recited in claim 3, wherein the metrics are presented as numbers.

5. A method as recited in claim 3, wherein the metrics are presented as a visual map.

6. A method as recited in claim 3, wherein the metric include one or more of the following: a count, a word frequency for the current search query, a word frequency for a plurality of search queries, a word frequency in anchor texts of the search results, a word frequency in user tags of the search results, a word frequency with respect to one or more search terms of the current search query or a plurality of search queries, a search result ranking metric, a term frequency (tf) metric, an inverse document frequency (idf) metric, or a tf-idf metric.

7. A method as recited in claim 6, wherein the words or phrases of the word or phrase index are presented in an order based on the metrics.

8. A method as recited in claim 1, wherein the words or phrases of the word or phrase index are presented in an order that corresponds to a frequency metric.

9. A method as recited in claim 8, wherein the frequency metric is a term frequency-inverse document frequency (tf-idf) metric.

10. A method as recited in claim 1, wherein the words or phrases of the word or phrase index are hierarchically presented.

11. A method as recited in claim 1, wherein the words or phrases of the word or phrase index are shown by a visual representation that corresponds to a metric of such words or phrases.

12. A method as recited in claim 1, further comprising altering a subsequent search based on the determined word or phrase index and/or user selection of one or more portions of the word or phrase index.

13. A method as recited in claim 1, wherein the word or phrase index is obtained only for the search results that are related to advertisements.

14. An apparatus comprising at least a processor and a memory, wherein the processor and/or memory are configured to perform the following operations:
when a plurality of search results are provided for a search query by a user, obtaining a word or phrase index for at least a portion of the search results, wherein the word or phrase index includes a plurality of words or phrases that are each associated with one or more search results that contain or use such associated words or phrases; and
providing the word or phrase index, along with the search results, to the user so that the search results of the word or phrase index are selectable by the user.

15. An apparatus as recited in claim 14, wherein the search results are documents, audio files, video files, or image files.

16. An apparatus as recited in claim 14, further comprising determining a metric for each word or phrase and/or for each search results of each word or phrase.

17. An apparatus as recited in claim 16, wherein the metrics are presented as numbers.

18. An apparatus as recited in claim 16, wherein the metrics are presented as a visual map.

19. An apparatus as recited in claim 16, wherein the metric include one or more of the following: a count, a word frequency for the current search query, a word frequency for a plurality of search queries, a word frequency in anchor texts of the search results, a word frequency in user tags of the search results, a word frequency with respect to one or more search terms of the current search query or a plurality of search queries, a search result ranking metric, a term frequency (tf) metric, an inverse document frequency (idf) metric, or a tf-idf metric.

20. A method as recited in claim 19, wherein the words or phrases of the word or phrase index are presented in an order based on the metrics.

21. An apparatus as recited in claim 14, wherein the words or phrases of the word or phrase index are presented in an order that corresponds to a frequency metric.

22. An apparatus as recited in claim 21, wherein the frequency metric is a term frequency-inverse document frequency (tf-idf) metric.

23. An apparatus as recited in claim 14, wherein the words or phrases of the word or phrase index are hierarchically presented.

24. An apparatus as recited in claim 14, wherein the words or phrases of the word or phrase index are shown by a visual representation that corresponds to a metric of such words or phrases.

25. An apparatus as recited in claim 14, further comprising altering a subsequent search based on the determined word or phrase index and/or user selection of one or more portions of the word or phrase index.

26. An apparatus as recited in claim 14, wherein the word or phrase index is obtained only for the search results that are related to advertisements.

27. At least one computer readable storage medium having computer program instructions stored thereon that are arranged to perform the following operations:
when a plurality of search results are provided for a search query by a user, obtaining a word or phrase index for at least a portion of the search results, wherein the word or phrase index includes a plurality of words or phrases that are each associated with one or more search results that contain or use such associated words or phrases; and
providing the word or phrase index, along with the search results, to the user so that the search results of the word or phrase index are selectable by the user.

28. At least one computer readable storage medium as recited in claim 27, wherein the search results are documents, audio files, video files, or image files.

29. At least one computer readable storage medium as recited in claim 27, further comprising determining a metric for each word or phrase and/or for each search results of each word or phrase.

30. At least one computer readable storage medium as recited in claim 29, wherein the metrics are presented as numbers.

31. At least one computer readable storage medium as recited in claim 29, wherein the metrics are presented as a visual map.

32. At least one computer readable storage medium as recited in claim 29, wherein the metric include one or more of the following: a count, a word frequency for the current search query, a word frequency for a plurality of search queries, a word frequency in anchor texts of the search results, a word frequency in user tags of the search results, a word frequency with respect to one or more search terms of the current search query or a plurality of search queries, a search result ranking metric, a term frequency (tf) metric, an inverse document frequency (idf) metric, or a tf-idf metric.

33. At least one computer readable storage medium as recited in claim 32, wherein the words or phrases of the word or phrase index are presented in an order based on the metrics.

34. At least one computer readable storage medium as recited in claim 27, wherein the words or phrases of the word or phrase index are presented in an order that corresponds to a frequency metric.

35. At least one computer readable storage medium as recited in claim 34, wherein the frequency metric is a term frequency-inverse document frequency (tf-idf) metric.

36. At least one computer readable storage medium as recited in claim 27, wherein the words or phrases of the word or phrase index are hierarchically presented.

37. At least one computer readable storage medium as recited in claim 27, wherein the words or phrases of the word or phrase index are shown by a visual representation that corresponds to a metric of such words or phrases.

38. At least one computer readable storage medium as recited in claim 27, further comprising altering a subsequent search based on the determined word or phrase index and/or user selection of one or more portions of the word or phrase index.

39. At least one computer readable storage medium as recited in claim 27, wherein the word or phrase index is obtained only for the search results that are related to advertisements.
